(19) United States
(12) Patent Application Publication
(10) Pub. No.: US 2018/0029403 A1
(43) Pub. Date: Feb. 1, 2018

(54) CLIPS AND METHODS OF USING SAME

(71) Applicant: EC Design, LLC, Hawthorne, CA (US)

(72) Inventor: Erin Condren, Hawthorne, CA (US)

(21) Appl. No.: 15/548,719

(22) PCT Filed: Feb. 5, 2016
(86) PCT No.: PCT/US2016/016861

§ 371 Date: Aug. 3, 2017

Related U.S. Application Data
(60) Provisional application No. 62/188,115, filed on Jul. 2, 2015.

(51) Int. Cl. B42F 11/00; B42F 13/00

(52) U.S. Cl. CPC B42F 11/00; B42F 13/00

(57) ABSTRACT

Clips and clip devices are described that can allow a user to at least temporarily attach a loose article to a binding mechanism, for example, a substantially cylindrical binding mechanism. Methods of using these devices are also described.

### CROSS REFERENCE TO RELATED APPLICATIONS

This application is a national phase entry of PCT/US2016/016861, filed Feb. 5, 2016, which claims the benefit of U.S. provisional patent application No. 62/113,315, filed Feb. 6, 2015, and U.S. provisional patent application No. 62/188,115, filed Jul. 2, 2015, the entire contents each of which is hereby incorporated by reference.

### SUMMARY

Clips and clip devices are described that can allow or are configured to allow a user to at least temporarily attach a loose article to a binding mechanism, for example, a substantially cylindrical binding mechanism. As a non-limiting example, a binding system can include a spiral or coil type of binding system used to create notebooks, pamphlets, booklets or other spiral or coil bound items. In some embodiments described herein, the spiral or coil bound item can be a yearly, monthly, or weekly calendar/planner.

Clips as described herein can be useful for inserting loose articles into a binding mechanism in between any page within the bound pages of notebooks, pamphlets, booklets or other spiral or coil bound items.

The clip devices described herein can include: a body section or portion comprising a top surface, a bottom surface, a first end, and a second end, wherein at least a portion of the bottom surface includes an adhesive; and at least one appendage configured to secure the body section to a binding mechanism. In one embodiment, the binding mechanism can be substantially cylindrical.

The at least one appendage can include a first rectilinear shape. The first rectilinear shape can include a rounded top end and two opposing pyramidal shapes that meet at a stem. The first rectilinear shape in other embodiments can include a flat end and two opposing pyramidal shapes that meet at a stem. The stem can be attached to the second end of body section.

In some embodiments, the clip devices described herein can include at least three appendages. In other embodiments, the clip devices can include at least seven appendages. The appendage(s) can be attached to the second end of the body section. Additional appendages can also be included, for example, on the second end of the body section. Additional appendages can have different shapes than the appendages. For example, additional appendages can be substantially the shape of an appendage cut in half. Additional appendages, in some embodiments, can include a second rectilinear shape including a substantially flat first side and an opposing pyramidal shape that meets at a stem. The clip devices described herein can include two additional appendages.

In some embodiments, the at least one appendage includes a substantially circular or elliptical shape attached to a stem.

The clip devices described herein can include body sections including a substantially straight first end that is curved at a first junction with a bottom end and is curved at a second junction with a top end. Further, the top surface and the bottom surface can be substantially flat.

The body section in some embodiments can include a distance from the top end to the bottom end. This distance can be less than about 5.5 cm. In other embodiments, this distance can be less than about 10.5 cm. Further, the body section can include a distance from the first end to the second end. This distance can be less than about 2.0 cm.

Further, in some embodiments, portions of the bottom surface of the body section can include an adhesive. The adhesive can be located on an area defined between the top end and the bottom end and the second end and a distance less than about 0.5 cm from the second end of the body section.

Methods of using the clip devices are also described. These methods can comprise: securing a body section of the clip device to a binding mechanism (e.g., substantially cylindrical binding mechanism) using at least one appendage, wherein the body section includes a top surface, a bottom surface, a first end, and a second end, wherein at least a portion of the top surface includes an adhesive.

The methods can further include peeling a cover off the adhesive to expose the adhesive. After peeling off a cover, a loose article can be attached to the adhesive thereby securing the loose article to the binding mechanism.

In some embodiments, the securing includes using force to snap the at least one appendage into an opening between two adjacent sections of the substantially cylindrical binding mechanism.

Methods can also include the step of securing the body section of at least a second clip device to the substantially cylindrical binding mechanism using at least one appendage on the second clip device. Then, the methods can include attaching a loose article to the adhesive on the first body section and the adhesive on the second body section thereby securing the loose article to the substantially cylindrical binding mechanism.

Additional features and advantages are described herein, and will be apparent from the following Detailed Description and figures.

### BRIEF DESCRIPTION OF THE DRAWINGS

FIG. 1 is a perspective view of an example clip as described herein.

FIG. 2 is view of a first end of the clip illustrated in FIG. 1.

FIG. 3 is a bottom view of the clip illustrated in FIG. 1.

FIG. 4 is view of a second end of the clip illustrated in FIG. 1.

FIG. 5 is a top end view of the clip illustrated in FIG. 1.

FIG. 6 is a top view of an example clip as illustrated in FIG. 1.

FIG. 7 is a bottom end view of the clip illustrated in FIG. 1.

FIG. 8 is a perspective view of another example clip as described herein.

FIG. 9 is a perspective view of the clip in FIG. 8 including a cap portion attached thereto.

FIG. 10 is a perspective view of another example clip as described herein.

FIG. 11 is an example clip with an adhesive strip and a peelable cover over the adhesive strip.

FIG. 12 illustrates another example clip as described herein including two ears with adhesive on each.

FIG. 13 illustrates another example clip as described herein including a transverse portion between two clips.

FIG. 14 illustrates a clip system as described herein.

FIG. 15 is a top view of another example clip as described herein.

FIG. 16 illustrates another embodiment of the clip of FIG. 15 including two clips attached to a single cap portion.

FIG. 17 is a top view of another example clip as described herein where two clips are included as a single unit.

### DETAILED DESCRIPTION

Described herein generally are stationery products and devices that can allow a user to attach and clip or clip and attach a loose article to a binding mechanism. In some embodiments, the devices can be used to clip a loose article to a binding mechanism. In other embodiments, the binding system is substantially cylindrical.

Clips as described herein can be useful for inserting and/or connecting loose articles into a binding mechanism. Loose articles can be virtually any substantially flat article that a user may wish to insert, clip, and/or attach into a binding mechanism. Articles can include, but are not limited to, a loose sheet of paper, a napkin, a notecard, an event ticket, a citation, an airline or other transportation ticket, a reminder note, a card, a flyer, a photograph, a post card, or the like. Clips can be useful, in some embodiments, to secure articles such as these into bound notebooks such as planners or scrapbooks. However, clips can also be useful for other types of bound materials such as manuals, medical notebooks, lab notebooks, and the like.

Binding mechanisms, e.g., substantially cylindrical binding mechanisms can be spiral or coil binding, comb binding, double loop binding (e.g., Wre-O binding), and ring binding. In some embodiments, the binding mechanisms can be formed of polymers such as plastics and thermosets, metal wires, cylinders or tubing, or a combination of metals and polymers such as coated metal wires. In some embodiments, the binding can lock and unlock. However, to use the presently described clips, the binding mechanism does not need to lock and unlock.

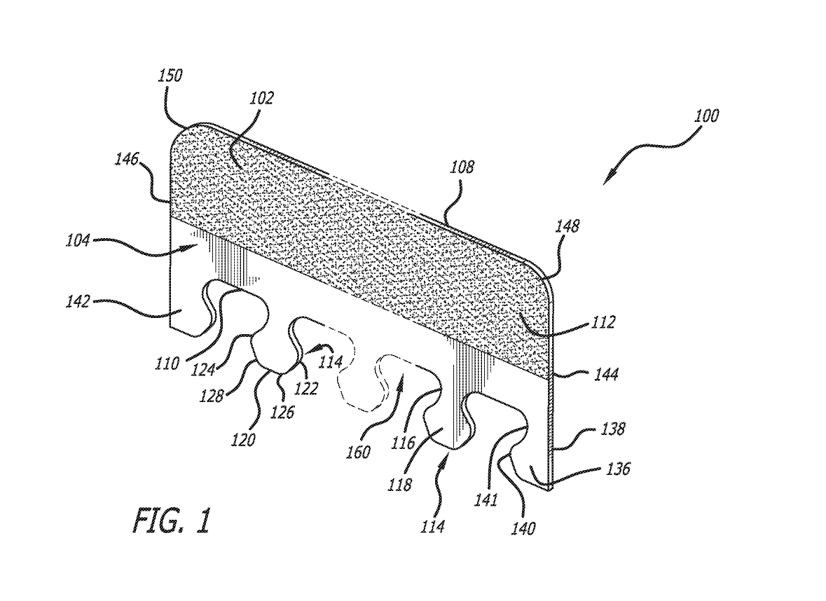

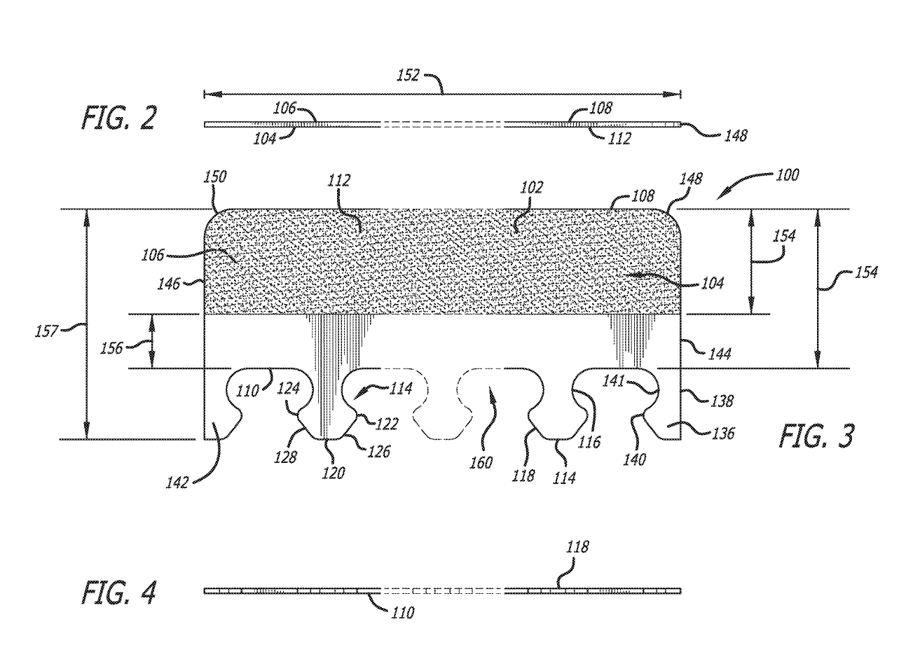

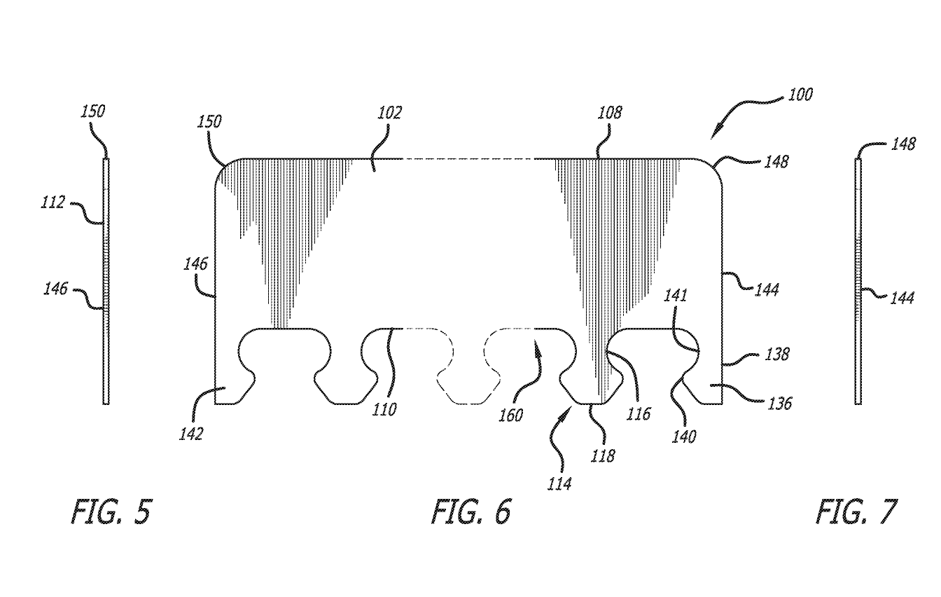

An example clip as described herein, clip 100, is illustrated in FIGS. 1-7. The clip illustrated in FIGS. 1-7 is for illustration only and shapes and sizes of various features of the clips can be varied. Clip 100 can include a body section 102. Body section 102 can include a top surface 104, a bottom surface 106, a first end 108, and a second end 110. In some embodiments, an adhesive 112 can cover at least a portion of bottom surface 106. In other embodiments, adhesive 112 can cover at least a portion of top surface 104. In still other embodiments, adhesive 112 can cover at least a portion of top surface 104 and at least a portion of bottom surface 106. In some embodiments, top surface 104 and bottom surface 106 are substantially flat.

Clip 100 also includes at least one appendage 114 configured to secure body section 102 to the substantially cylindrical binding mechanism. At least one appendage 114 can be attached to second end 110. However, in other embodiments, at least one appendage 114 can be attached to first end 108. In still other embodiments, at least one appendage 114 can be attached to first end 108 and at least one additional appendage can be attached to second end 110.

Each appendage can include a stem 116 and a head 118. Head 118 can be any shape that can allow clip 100 to rest securely within a substantially cylindrical binding mechanism. In one embodiment, head can be substantially circular, substantially elliptical, substantially triangular, or substantially diamond shaped. In some embodiments, other rectilinear shapes can be used. In various embodiments, the above shapes and any other shapes described herein can include curved corners to prevent injury.

In one embodiment, as illustrated in FIG. 1, appendage 114 can have a rectilinear shape. The rectilinear shape can have 4 corners. The rectilinear shape can include rounded end 120 and a first pyramidal shape 122 and a second pyramidal shape 124 that meet at stem 116. First pyramidal shape 122 and a second pyramidal shape 124 can oppose one another and meet at stem 116. In some embodiments, rounded end 120 may be flat and meet the opposing pyramidal shapes and first corner 126 and second corner 128.

In one embodiment, the shape of appendage 114 can be defined as a trapezoid with a taper into stem 116. In some embodiments, stem 116 can also taper into second end 110. Further, in various embodiments, any junction on clip 100 can have a tapered transition.

FIGS. 1-7 show clip 100 as having a height that can vary between embodiments, the dashed portions illustrate a portion of clip 100 that can be varied between embodiments. For example, where dashed appendage is located, this portion of the clip can be repeated as necessary to achieve the desired height of the device.

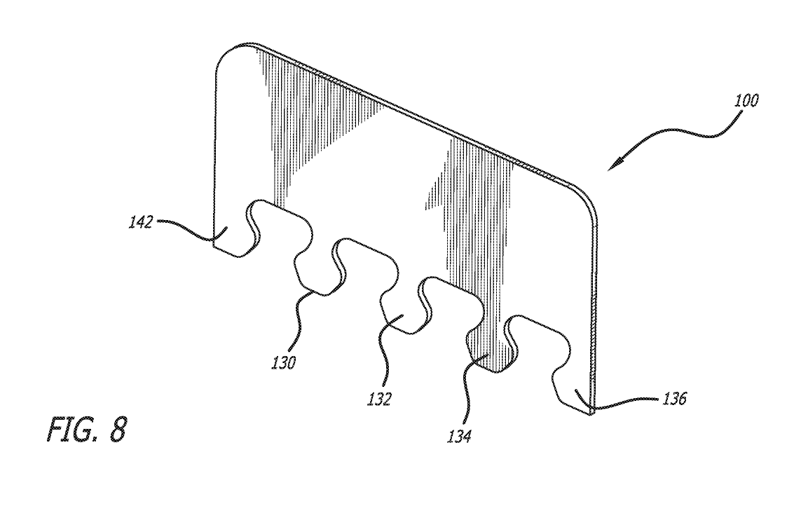

In one embodiment, clip 100 can include two, three, four, five, six, seven, eight, nine, ten, eleven, twelve, 13, 14, 15, 16, 17, 18, 19, 20, 21, 22, 23, 24, 25, 26, 27, 28, 29, 30, or more appendages. Some embodiments, such as that illustrated in FIG. 8 can include three appendages such as first appendage 130, second appendage 132, and third appendage 134.

Clip 100 can further include at least one additional appendage 136. At least one additional appendage 136 can include a second rectilinear shape comprising a substantially flat first side 138 and an opposing pyramidal shape 140 that meets at stem 141. In one embodiment, additional appendage 136 can taper into stem 141. In some embodiments, stem 141 can also taper into second end 110 at least on the surface opposing top or bottom end of body section 102.

In other embodiments, clip 100 can include a second additional appendage 142 which can be a mirror image of at least one additional appendage 136. In such an embodiment, at least one additional appendage 136 can be located at bottom end 144 of body section 102 and second additional appendage 142 can be located at top end 146 of body section 102. In other words, additional appendages can flank appendages 114 and provide a flat top and bottom surface for clip 100.

Further, body section 102 can include first end 108 that is substantially straight but is curved at a first junction 148 with bottom end 144 and is curved at a second junction 150 with top end 146.

Clip 100 can include body section 102 that is dimensioned for a particular application and/or dimensioned to fit within or along a particular binding mechanism. For example, body section 102 can include a height 152. Height 152 of body section 102 can be long enough to provide enough appendages to secure a article to a binding mechanism. In some embodiments, height 152 can be about 2 cm, about 2.5 cm, about 3 cm, about 3.5 cm, about 4 cm, about 4.5 cm, about 5 cm, about 5.1 cm, about 5.2 cm, about 5.3 cm, about 5.4 cm, about 5.5 cm, about 6.0 cm, about 6.5 cm, about 7 cm, about 7.5 cm, about 8 cm, about 8.5 cm, about 9 cm, about 9.5 cm, about 10 cm, about 10.1 cm, about 10.2 cm, about 10.3 cm, about 10.4 cm, about 10.5 cm, about 10.6 cm, about 10.7 cm, about 10.8 cm, about 10.9 cm, about 11 cm, about 11.5 cm, about 12 cm, about 15 cm, about 20 cm, about 25 cm, about 28 cm, less than about 30 cm, less than about 20 cm, less than about 11 cm, less than about 10 cm, less than about 5.5 cm, between about 4 cm and about 6 cm, between about 5 cm and about 6 cm, between about 2 cm and about 10 cm, or between about 10 cm and about 11 cm, between about 2 cm and about 30 cm. In one embodiment, height 152 is about 5.3 cm. In another embodiment, height 152 is about 10.48 cm.

Clip 100 can include body section 102 that is dimensioned for a particular application and/or dimensioned to fit a particular item(s). For example, body section 102 can include a width 154. Width 154 of body section 102 can be long enough to provide enough surface area to allow sufficient adhesive to secure an article to a binding mechanism. In some embodiments, width 154 can be about 0.5 cm, about 1 cm, about 1.1 cm, about 1.2 cm, about 1.3 cm, about 1.4 cm, about 1.5 cm, about 1.6 cm, about 1.7 cm, about 1.8 cm, about 1.9 cm, about 2 cm, about 2.5 cm, about 3 cm, about 3.5 cm, about 4 cm, about 4.5 cm, about 5 cm, about 5.5 cm, about 6.0 cm, about 6.5 cm, about 7 cm, about 7.5 cm, about 8 cm, about 8.5 cm, about 9 cm, about 9.5 cm, about 10 cm, less than about 10 cm, less than about 5 cm, less than about 2 cm, between about 1 cm and about 2 cm, between about 1 cm and about 5 cm, between about 1 cm and about 10 cm, or between about 1.5 cm and about 2 cm. In one embodiment, width 154 is about 1.8 cm.

Adhesive 112 can have an adhesive width 155. Adhesive width 155 can be about 0.5 cm, about 1 cm, about 1.1 cm, about 1.2 cm, 1.24 cm, 1.25 cm, about 1.26 cm, 1.27 cm, 1.28 cam, 1.29 cm, about 1.3 cm, about 1.4 cm, about 1.5 cm, about 1.6 cm, about 1.7 cm, about 1.8 cm, about 1.9 cm, about 2 cm, about 2.5 cm, about 3 cm, about 3.5 cm, about 4 cm, about 4.5 cm, about 5 cm, about 5.5 cm, about 6.0 cm, about 6.5 cm, about 7 cm, about 7.5 cm, about 8 cm, about 8.5 cm, about 9 cm, about 9.5 cm, about 10 cm, less than about 10 cm, less than about 5 cm, less than about 2 cm, between about 1 cm and about 2 cm, between about 2 cm and about 1.3 cm, between about 1 cm and about 10 cm, or between about 1.26 cm and about 1.28 cm. In one embodiment, adhesive width 155 is about 1.27 cm.

In some embodiments, distance 156 which is the distance from second end 110 to the edge of adhesive 112 can be about 0.1 cm, about 0.2 cm, about 0.3 cm, about 0.4 cm, about 0.5 cm, about 0.6 cm, about 0.7 cm, about 0.8 cm, about 0.9 cm, about 1 cm, about 1.5 cam, about 2 cm, less than about 2 cm, less than about 1 cm, less than about 0.6 cm, between about 0.1 cm and about 1 cm, between about 0.4 cm and about 0.6 cm, or between about 0.1 cm and about 2 cm. In one embodiment, distance 156 is about 0.5 cm.

Clip 100 can also have a total width 157 from first end 108 to the end of appendages. Total width 157 can be about 2 cm, about 2.1 cm, about 2.2 cm, about 2.3 cm, about 2.4 cm, about 2.5 cm, about 2.6 cm, about 2.7 cm, about 2.8 cm, about 2.9 cm, about 3 cm, about 3.5 cm, about 4 cm, about 4.5 cm, about 5 cm, about 5.5 cm, about 6.0 cm, about 6.5 cm, about 7 cm, about 7.5 cm, about 8 cm, about 8.5 cm, about 9 cm, about 9.5 cm, about 10 cm, less than about 10 cm, less than about 6 cm, less than about 3 cm, between about 1 cm and about 3 cm, between about 2 cm and about 3 cm, between about 1 cm and about 10 cm, or between about 1.5 cm and about 4 cm. In one embodiment, width 154 is about 2.54 cm.

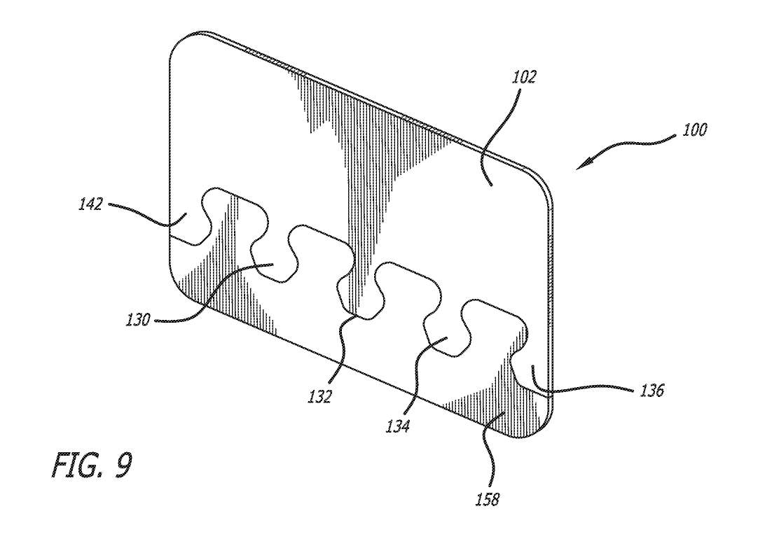

In some embodiments, as illustrated in FIG. 9, clip 100 can be provided with a cap portion 158 that can fit within voids 160 that exist between adjacent appendages and protrude beyond the ends of appendage heads. In one embodiment, cap portion 158 can be the negative space around the appendaged side of clip 100.

In some embodiments, cap portion 158 can be irreversibly attached to clip 100 such that cap portion 158 snaps off clip 100 and can be discarded.

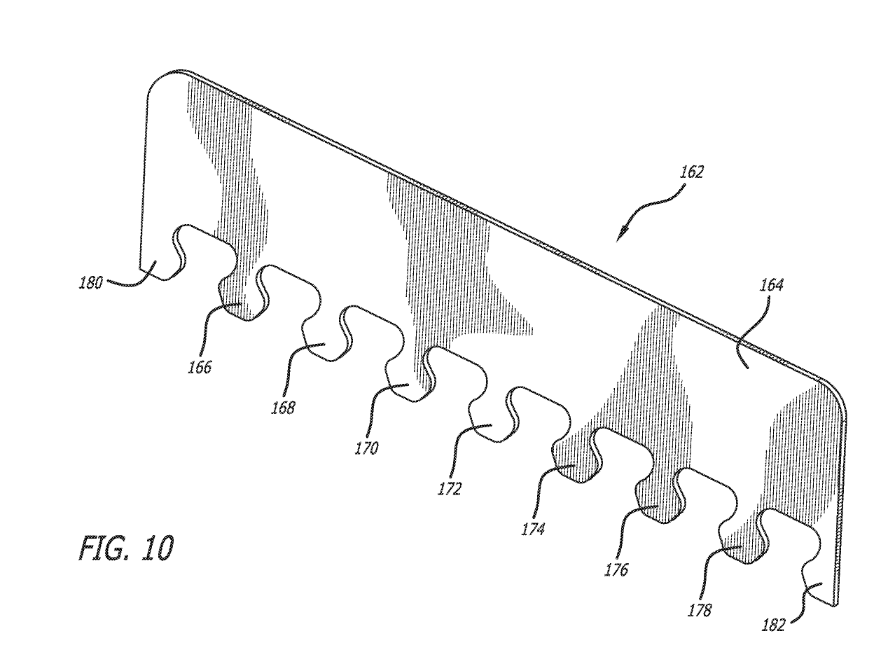

Another example clip is illustrated in FIG. 10. Clip 162 includes body 164 with seven appendages such as first appendage 166, second appendage 168, third appendage 170, fourth appendage 172, fifth appendage 174, sixth appendage 176, seventh appendage 178. Clip 162 can also include two additional appendages such as first additional appendage 180, and second additional appendage 182. In some embodiments, first additional appendage 180 can oppose second additional appendage 182. Other numbers of appendages are within the scope of the present disclosure.

Again, body 164 can include at least a portion covered with an adhesive as described herein.

Adhesives described herein can include adhesives or other attachment mechanisms with sufficient bonding properties to allow an article to be attached to body section 102. The article can be removably attached to the adhesive. In some embodiments, adhesive can provide a permanent irremovable bond to an article. Adhesives can include polymer dispersion adhesives, emulsion adhesives, acrylate based polymer adhesives, thermoplastics, starches, protein-based adhesives, elastomers, combinations thereof, and the like. More specifically, adhesives can include, but are not limited to rubber, polychloroprene, rubber cement, polyvinyl acetate, ethylene-vinyl acetate, polyesters, polyurethanes, epoxides, cyanoacrylates, urethanes, and/or lignin.

Adhesives can also include other attachment mechanisms with sufficient bonding properties to allow an article to be attached to body section 102. Other attachment mechanisms can include but are not limited to magnets, snaps, and hook and loom connections such as VELCRO®.

Adhesive 112 can be provided as a strip of adhesive. In other embodiments, adhesive can be provided as circular or other shaped spots. Also, multiple strips of adhesive can be provided. In one embodiment, adhesive can be provided on bottom surface 106 including an area defined between top end 146, bottom end 144, first end 108, and a distance 156 from second end 110.

Adhesives as described herein can be protected when delivered to a user with a cover 184 as illustrated in FIG. 11. Covers 184 can be in the form of a peelable strip that protects the adhesive until use. In some embodiments, a cover 184 can be reapplied to the adhesive after use in order to preserve the adhesive for subsequent uses.

Clip 100 can be formed of materials that can sustain the forces placed on them by the article attached to them. For example, clip 100 can be formed of metal, polymeric materials, plastics, or a combination thereof such as a polymer coated metal. In some embodiments, the materials and methods chosen to form the herein described clips can be those that provide the thinnest and lightest final product. Thin and light are desired because if multiple clips are used in a bound booklet, notebook, or pamphlet, the area of stacked clips can cause a bulge. The thinner the clip, the lesser the bulge that will result. Also, clips can add weight. Thus, the lighter the clips the less weight that will be added to a bound booklet, notebook, or pamphlet.

For example, in some embodiments, clip 100 can be formed of a plastic or other polymeric material such as, but not limited to rubber, synthetic rubber, silicone polymers, thermoplstics, thermosets, polyolefins, polyisobutylene, acrylic polymers, ethylene-co-vinylacetate, polybutylmethacrylate, vinyl halide polymers (for example, polyvinyl chloride), polyvinyl ethers (for example, polyvinyl methyl ether), polyvinylidene halides, polyacrylonitrile, polyvinyl ketones, polyvinyl aromatics, polyvinyl esters, acrylonitrile-styrene copolymers, ABS resins, ethylene-vinyl acetate copolymers, polyamides (for example, Nylon 66 and polycaprolactam), alkyd resins, polycarbonates, polyoxymethylenes, polyimides, polyethers, epoxy resins, polyurethanes, rayon, cellulose, cellulose acetate, cellulose butyrate, cellulose acetate butyrate, cellophane, cellulose nitrate, cellulose propionate, cellulose ethers, carboxymethyl cellulose, polytetrafluororethylene (for example, TEFLON®) and combinations thereof.

Also, in other embodiments, clip 100 can be formed of metal such as, but not limited to aluminum, titanium, zinc, platinum, tantalum, copper, nickel, rhodium, gold, silver, palladium, chromium, iron, indium, ruthenium, osmium, tin, iridium, or combinations, and alloys thereof.

Again, clips can be formed of metal and coated or encased in a polymer or plastic.

Clip 100 can be formed by any method that can provide a clip with desired properties as described herein. For example, clips can be formed by injection molding, 3D printing, punching from a sheet of material, casting, or the like.

In one embodiment, clips and/or cap portions can be punched using a die. Sheets of polymeric material of an appropriate thickness can be used. To these sheets can be added strips of adhesive with protective covers already attached or added prior to punching at specific locations that will reside on the final clips. Once the adhesive strips and covers are added to the sheets of polymeric material, clips can be punched out of the polymeric material with adhesive strips and covers already applied. In some embodiments, clips and cap portions can be punched in a single pass as a single unit. In other embodiments, clips and cap portions can be punched out separately and assembled prior to packaging. In one embodiment, lines including multiple clips and cap portions can be punched out of a sheet of polymeric material simultaneously.

In another embodiment, a roll of polymeric material including adhesive and cover can be fed into a die cutting machine with a wheel that continuously cuts out clips and cap portions as a single unit.

Other methods of manufacture are also within the scope of the present disclosure.

Top surface 104 and bottom surface 106 can be a printable surface that can allow company logos, instructions, or other information to be printed thereon or therein. Further, top surface 104 and bottom surface 106 can be textured to allow for easy handling and gripping of a clip during use.

Methods of using the herein described clips are also described. In some embodiments, methods can include attaching or securing a clip as described to a binding mechanism and then attaching an article to adhesive associated with the clip. Attachments or securing can be accomplished using at least one appendage as described herein associated with a binding mechanism. The attaching or securing can be referred to as clipping.

Methods can include a step of peeling a cover off the adhesive to expose the adhesive before attaching an article to the body portion of a clip.

The securing step can be accomplished by providing enough force to snap the at least one appendage into an opening between two adjacent sections of a binding mechanism.

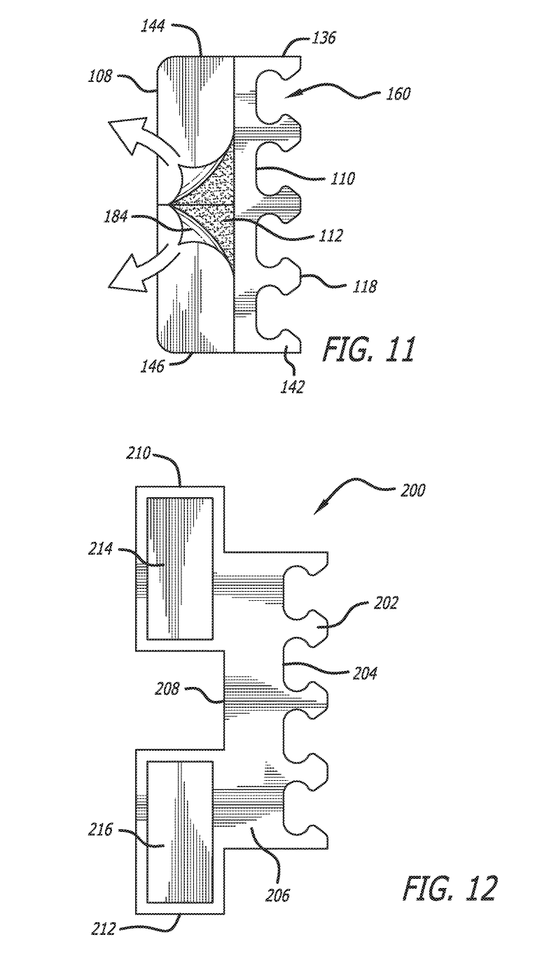

An example embodiment of an alternative clip configuration is illustrated in FIG. 12. Clip 200 includes appendages 202 on the second end 204 of body 206 as described herein. In addition, first end 208 of body 206 can include first ear 210 and second ear 212. First ear 210 can include first adhesive portion 214 and second ear 212 can include second adhesive portion 216. Clip 200 can be used in some embodiments to attach two articles, one article on each ear, to a binding mechanism. Also, both ears can be used to attach a single article with more adhesion power.

First ear 210 and second ear 212 can be any shape such as but not limited to circular, square, rectangular, elliptical, triangular, trapezoidal, a parallelogram, other rectilinear shapes, combinations thereof, and the like. In some embodiments, corners of the ears can be rounded to prevent sharp corners.

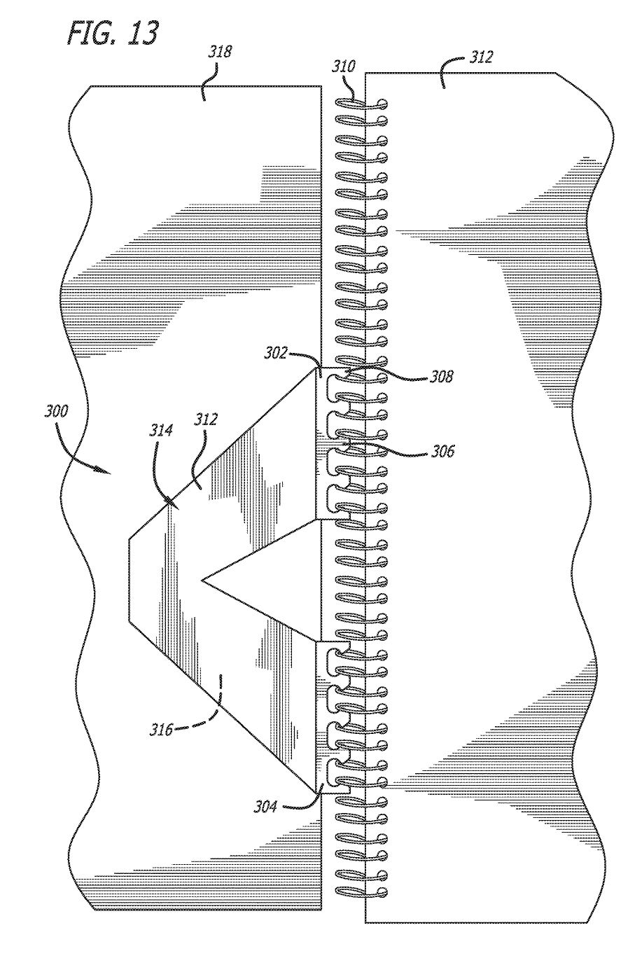

In some embodiments, a clip can include multiple body sections. For example as illustrated in FIG. 13, clip 300 includes first body portion 302 and second body portion 304. Each body portion can include at least one appendage 306 and at least one second type of appendage 308. The appendages can engage binding mechanism 310 which holds together bound pages 312. In this example embodiment, binding mechanism 310 is a spiral binding, but as noted herein binding mechanism 310 can encompass other types of binding mechanisms.

Clip 300 further includes a transverse section 312 that links first body portion 302 and second body portion 304. Transverse portion 312 can be at least partially covered on a first surface 314 and/or a second surface 316 with an adhesive. The adhesive can be used to attach article 318 to binding mechanism 310.

In FIG. 13, transverse section 312 has a pyramidal or triangular shape. However, transverse section 312 can have other shapes such as, but not limited to, arcs, half circles, portions of an ellipse, trapezoids, circles, squares, rectangles, parallelograms, other rectilinear shapes, combinations thereof, and the like.

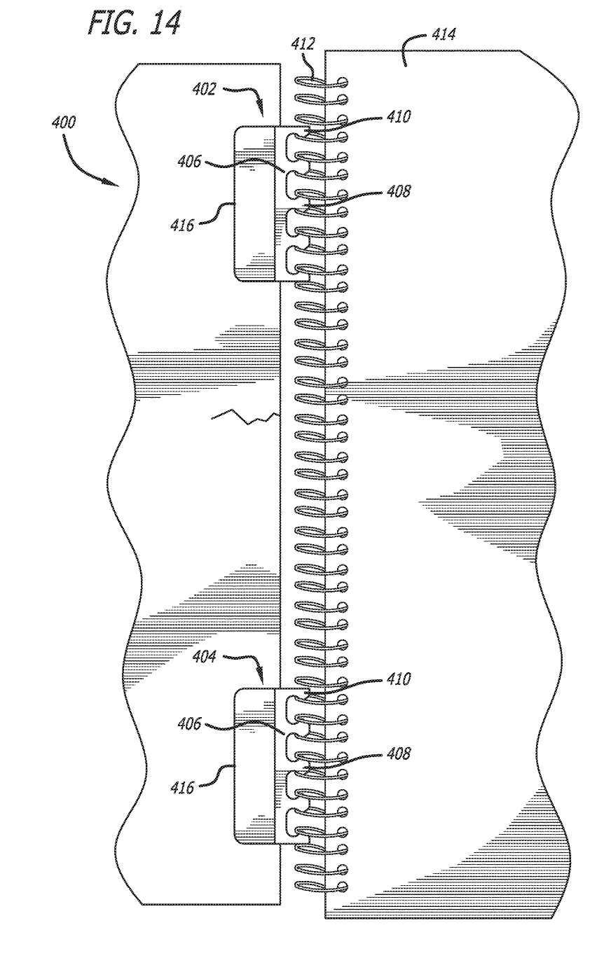

In some embodiments, second and subsequent clips can be used to attach an article to a binding mechanism. Such configurations can be referred to as clip systems. Clip system 400 is illustrated in FIG. 14. Clip system 400 includes first clip 402 and second clip 404. Each clip includes body 406 including at least one appendage 408 and at least one second type of appendage 410. The appendages can engage binding mechanism 412 which holds together bound pages 414. Again, in this example embodiment, binding mechanism 412 is a spiral binding, but as noted herein binding mechanism 412 can encompass other types of binding mechanisms.

First clip 402 and second clip 404 further include adhesive 416 on at least potions of body 406.

FIG. 14 also illustrates how the presently described clips removably attach to a binding mechanism such as a spiral or coil binding. In some embodiments, an appendage can wedge between adjacent winds in a spiral or coil allowing the stem to sit between the spiral or coil and the opposing pyramidal shapes holding the clip from coming off the spiral or coil binding. In various embodiments, an open wind of spiral or coil can exist between each appendage. In other embodiments, no empty wind can exist between appendages or in other words, appendages are closer together and fit between each wind. In still other embodiments, appendages can skip two three, four, five, or more winds. The number and spacing of appendages can be determined based on a specific need.

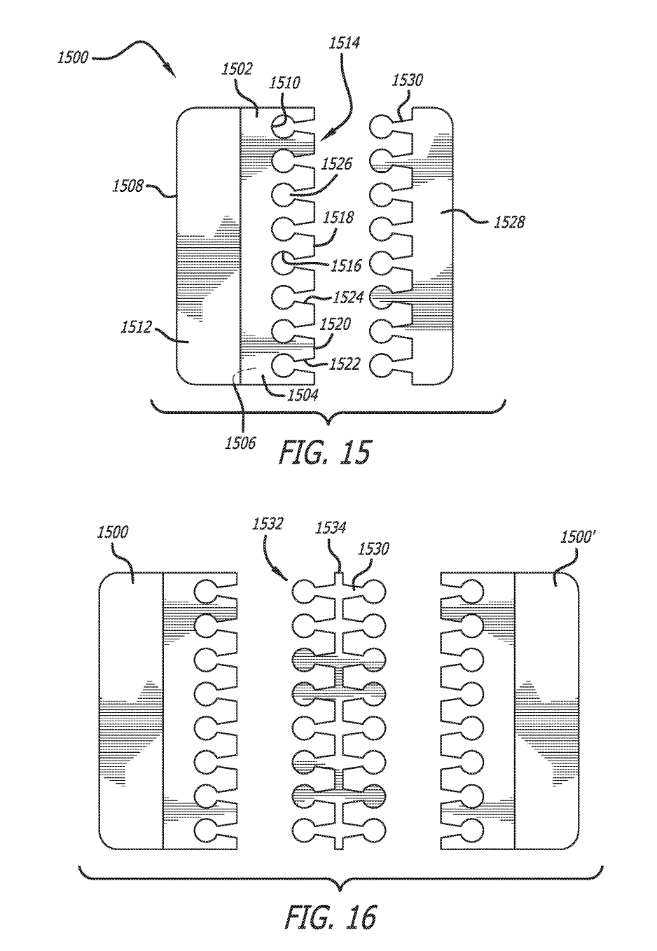

FIG. 15 illustrates another example clip, clip 1500. Clip 1500 is for illustration only and shapes and sizes of various features of this clip can be varied. Clip 1500 can include a body section 1502. Body section 1502 can include a top surface 1504, a bottom surface 1506, a first end 1508, and a second end 1510 in a similar fashion to other clips described herein. Clip 1500 can also include an adhesive 1512 that can cover at least a portion of bottom surface 1506. Adhesive can cover any portion of clip 1500 including those described herein.

Clip 1500 also includes at least one appendage 1514 configured to secure body section 1502 to the substantially cylindrical binding mechanism. At least one appendage 1514 can be attached to any portion of clip 1500 including those described herein.

Each appendage can include a stem 1516 and a head 1518. Head 1518 can be any shape that can allow clip 100 to rest securely within a substantially cylindrical binding mechanism. Here, appendage 1514 can have a rectilinear shape. The rectilinear shape can have 4 corners. The rectilinear shape can include flat end 1520 and a first pyramidal shape 1522 and a second pyramidal shape 124 that meet at stem 116. First pyramidal shape 122 and a second pyramidal shape 1524 can oppose one another and meet at stem 1516.

Clip 1500 can include a void 1526 between each adjacent appendage. Here, void 1526 is circular. However, in other embodiments, void 1526 can be substantially circular, oval, elliptical (e.g., see FIGS. 1-7), rectangular, square, or any other rectilinear shape.

In one embodiment, clip 1500 can include 17 appendages. In another embodiment, clip 1500 can include 15 appendages. In still another embodiment, clip 1500 can include 9 appendages. In yet another embodiment, clip 1500 can include 7 appendages.

Clip 1500 can be provided with a cap 1528 that can include appendages 1530 that fit within and around the voids 1526 and appendages 1514 of clip 1500. Cap 1528 can be shipped on clip 1500 and broken off at another point as described herein.

FIG. 16 illustrates another embodiment of clip 1500. Here, when manufactured and/or shipped, clip 1500 and second clip 1500′ are joined by a joining portion 1532. Joining portion 1532 includes a body portion 1534 in its center and appendages 1530 emanating from both sides thereof to join to clip 1500,1500′.

This configuration in some embodiments can allow for less waste as two clips can be manufactured with only one throw-away portion.

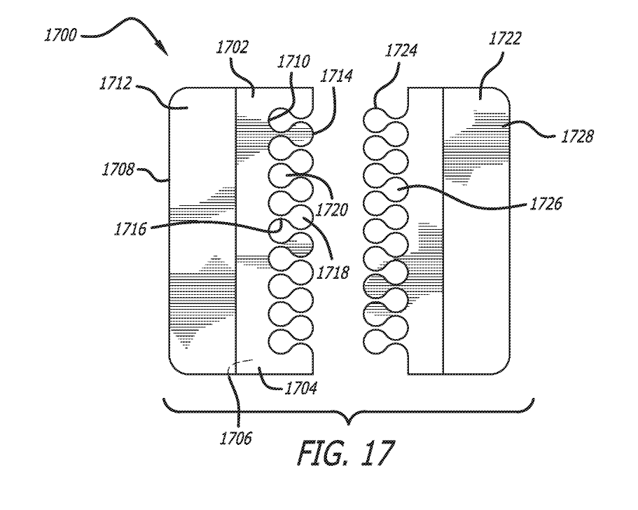

Another embodiment is illustrated in FIG. 17. Clip 1700 is for illustration only and shapes and sizes of various features of this clip can be varied. Clip 1700 can include a body section 1702. Body section 1702 can include a top surface 1704, a bottom surface 1706, a first end 1708, and a second end 1710 in a similar fashion to other clips described herein. Clip 1700 can also include an adhesive 1712 that can cover at least a portion of bottom surface 1706. Adhesive can cover any portion of clip 1700 including those described herein.

Clip 1700 also includes at least one appendage 1714 configured to secure body section 1702 to the substantially cylindrical binding mechanism. At least one appendage 1714 can be attached to any portion of clip 1700 including those described herein.

Each appendage can include a stem 1716 and a head 1718. Here, head 1718 is substantially circular and curves into substantially circular voids 1720. Clip 1700 can include a void between each adjacent appendage.

Clip 1700 can be provided with a cap 1722 that can include appendages 1724 and voids 1726 that are mirror images of least one appendage 1714 and voids 1720. Here, cap 1722 can be shipped on clip 1700 and broken off at another point as described herein. In this embodiment, cap 1722 can be used as a clip described herein and can include an adhesive 1728 as described herein.

This configuration in some embodiments can allow for no waste as two clips can be manufactured with no throw-away portion.

Clips as described herein can include a body section such as body section 102 that is of a size large enough that at least one removably attached article or set of articles can be included on one of its surfaces. In other embodiments, one or more clips can be used to attach a dashboard including at least one removably attached article or set of articles. These clips can be formed as part of a dashboard or can be attached to the dashboard using an adhesive as described herein. In some embodiments, dashboards can include one or more appendages as described herein used to attach the dashboards to a binding mechanism. A dashboard can be used as a front or back cover.

Removably attached articles can include sticky tabs, adhesive-backed note pads, stickers, magnets, sticky flags, note tabs and the like. In some embodiments, removably attached articles can include stacks of sticky tabs, adhesive-backed note pads, stacks of stickers, stacks of magnets, stacks of sticky flags, stacks of note tabs, and the like. Removably attached articles can be of various colors and/or can have different visual designs to identify the purpose of the removably attached article being used. Further, removably attached articles can have various shapes and sizes that may be desired by a particular user.

Removably attached articles can have at least a portion of its inside surface or base sheet or tab an adhesive that attaches the article in a permanent fashion to a body section or a surface attached to a binding mechanism using one or more clips described herein. In other embodiments, the attachment is not permanent, but has sufficient strength to hold removably attached articles onto body or a surface attached to a binding mechanism using one or more clips described herein.

In one embodiment, body section can include a first removably attached article, a second removably attached article, a third removably attached article, a fourth removably attached article, a fifth removably attached article, a sixth removably attached article, a seventh removably attached article, an eighth removably attached article, a ninth removably attached article, a tenth removably attached article, an eleventh removably attached article, and a twelfth removably attached article. In one embodiment, first removably attached article, second removably attached article, third removably attached article, tenth removably attached article, eleventh removably attached article, and twelfth removably attached article can be sticky flag style articles and fourth removably attached article, fifth removably attached article, sixth removably attached article, seventh removably attached article, eighth removably attached article, and ninth removably attached article can be sticky note style articles.

In other embodiments, different combinations of articles and/or shapes and sizes of articles can be included on a dashboard.

In some embodiments, a body section or a surface attached to a binding mechanism using one or more clips can include non-removable articles in addition to or replacing removably attached articles. Any number or combination of removably attached articles and non-removable articles can be included on a body section or a surface attached to a binding mechanism using one or more clips. Non-removable articles can have various shapes and sizes.

A dashboard can be dimensioned for a particular application and/or dimensioned to fit within or along a particular binding mechanism. For example, a dashboard can include a height that extends from a top edge to a bottom edge. Height can be long enough to provide enough space for clips or clip appendages to secure a dashboard to a binding mechanism. In some embodiments, height can be about 12 inches, about 11.5 inches, about 11 inches, about 10.5 inches, about 10 inches, about 9.5 inches, about 9.25 inches, about 9 inches, about 8.5 inches, about 8 inches, about 7.5 inches, about 7 inches, about 6.5 inches, about 6 inches, about 5.5 inches, about 5 inches, about 4.5 inches, about 4 inches, between about 12 inches and about 11 inches, between about 9 inches and about 10 inches, between about 4 inches and about 6 inches, or between about 4 inches and about 8 inches. In one embodiment, height is about 5.5 inches.

Further, a dashboard can include a width that extends from an inside edge to an outside edge. Width of a dashboard can be long enough to provide enough surface area for a dashboard to include a desired number of removably attached articles. In some embodiments, width can be about 10 inches, about 9 inches, about 8 inches, about 7 inches, about 7.5 inches, about 7.25 inches, about 7 inches, about 6.5 inches, about 6 inches, about 5.5 inches, about 5 inches, about 4.5 inches, about 4 inches, about 3.5 inches, abut 3 inches, between about 10 inches and about 8 inches, between about 7 inches and about 6 inches, or between about 4 inches and about 3 inches. In one embodiment, width is about 7.25 inches.

Dashboards can also have a thickness. Thickness can be a thickness sufficient to hold articles without deforming shape or cracking. Thickness can be about 0.2 inches, about 0.1 inches, about 0.15 inches, about 0.125 inches, about 0.01 inches, between about 0.01 inches and about 0.1 inches, or between about 0.1 and 0.2. In some embodiments, thickness is at least about 0.1 inches or about 0.12 inches.

Dashboards in some embodiments can have articles attached to its front side, to its back side, or both. For example, if used as a front cover, the back side can include articles. Likewise, if used as a back cover, the front side can include articles. Further still, if used as an insert, both the front side and the back side can include articles. When used as an insert, in some embodiments either the front side or the back side can include articles.

A dashboard can be formed of an appropriate material. For example, in some embodiments, a dashboard can be formed of a plastic or other polymeric material such as, but not limited to rubber, synthetic rubber, polyesters, silicone polymers, thermoplstics, thermosets, polyolefins, polyisobutylene, acrylic polymers, ethylene-co-vinylacetate, polybutylmethacrylate, vinyl halide polymers (for example, polyvinyl chloride), polyvinyl ethers (for example, polyvinyl methyl ether), polyvinylidene halides, polyacrylonitrile, polyvinyl ketones, polyvinyl aromatics, polyvinyl esters, acrylonitrile-styrene copolymers, ABS resins, ethylene-vinyl acetate copolymers, polyamides (for example, Nylon 66 and polycaprolactam), alkyd resins, polycarbonates, polyoxymethylenes, polyimides, polyethers, epoxy resins, polyurethanes, rayon, cellulose, cellulose acetate, cellulose butyrate, cellulose acetate butyrate, cellophane, cellulose nitrate, cellulose propionate, cellulose ethers, carboxymethyl cellulose, polytetrafluororethylene (for example, TEFLON®) and combinations thereof. In some embodiments, a dashboard can be a plastic or other polymeric material coated onto or covering a paper product. In one embodiment, a dashboard can be made of a polyester based material with a co-polymer low-melt aggressive adhesive. The dashboard can be 5 mil, 10 mil, 20 mil, 30 mil or more in thickness.

In some embodiments, a dashboard can include at least a portion thereof that is at least partially transparent. In one embodiment, the entirety of a dashboard is at least partially transparent.

Also, in other embodiments, a dashboard can be formed of a metal such as, but not limited to aluminum, titanium, zinc, platinum, tantalum, copper, nickel, rhodium, gold, silver, palladium, chromium, iron, indium, ruthenium, osmium, tin, iridium, or combinations, and alloys thereof. A dashboard can also be formed of metal or a textile such as paper and coated or encased in a polymer or plastic. In some embodiments, the encasement can be a lamination.

A dashboard can be formed as or include any other feature described herein.

In one embodiment, body section can include removably attached articles for example on the top portion of body section and a pouch for holding loose materials can be located on the bottom portion of body section. In some embodiments, this orientation be reversed or can be oriented right and left.

Further, methods of using clip systems such as clip system 400 can include the step of securing a body section of a second clip device to the binding mechanism using at least one appendage on the second clip device. Further, methods can include the step of securing a body section of a third, fourth, fifth, sixth or subsequent clip to the binding mechanism using at least one appendage on the a respective clip. Once a desired number of clips have been attached the binding mechanism, a loose article can be attached to the adhesives on the body sections of the clips thereby securing the loose article to the binding mechanism.

Clips as described herein can be provided as kits or as a part of a kit. A kit can include one or more clips as described herein and instructions for use thereof. Kits can include two, three, four, five, six, seven, eight, nine, ten, eleven, twelve, or more clips.

In other embodiments, a kit can include a bound article such as a booklet, pamphlet, notebook or the like having a binding mechanism as described herein and at least one clip as described herein. For example, a spiral bound booklet and at least one clip can be packaged with or without instructions for use as a kit. In one embodiment, the spiral bound booklet can be a personal planner, such as but not limited to a yearly planner. Also, again, such a kit can include two, three, four, five, six, seven, eight, nine, ten, eleven, twelve, or more clips.

Further, kits as described herein that include more than one clip can include more than one type of clip. For example, various combinations of clips can be included in the kits.

Unless otherwise indicated, all numbers expressing quantities of ingredients, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a” and “an” and “the” and similar referents used in the context of describing embodiments (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

The use of the term “or” in the claims is used to mean “and/or” unless explicitly indicated to refer to alternatives only or the alternatives are mutually exclusive, although the disclosure supports a definition that refers to only alternatives and “and/or.”

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments are described herein, including the best mode known for carrying out the invention. Of course, variations on those preferred embodiments will become apparent to those of ordinary skill in the art upon reading the foregoing description. Those of ordinary skill in the art are expected to employ such variations as appropriate, and embodiments described herein are to be practiced otherwise than specifically described herein. Accordingly, embodiments herein include all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

Further, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

We claim:

1. A clip device comprising:
a body section including a top surface, a bottom surface, a first end, and a second end, wherein at least a portion of the bottom surface includes an adhesive; and
at least one appendage configured to secure the body section to a substantially cylindrical binding mechanism.

2. The clip device of claim 1, wherein the at least one appendage includes a first rectilinear shape.

3. The clip device of claim 2, wherein the first rectilinear shape includes a rounded end and two opposing pyramidal shapes that meet at a stem.

4. The clip device of claim 2, wherein the first rectilinear shape includes a flat end and two opposing pyramidal shapes that meet at a stem.

5. The clip device of claim 2 including three or seven appendages.

6. The clip device of claim 1, wherein the at least one appendage is attached to the second end.

7. The clip device of claim 1, further comprising at least one additional appendage.

8. The clip device of claim 6, wherein the at least one additional appendage includes a second rectilinear shape including a substantially flat first side and an opposing pyramidal shape that meets at a stem.

9. The clip device of claim 6 including two additional appendages.

10. The clip device of claim 1, wherein the at least one appendage includes a substantially elliptical shape attached to a stem.

11. The clip device of claim 1, wherein the body section includes a substantially straight first end that is curved at a first junction with a bottom end and is curved at a second junction with a top end.

12. The clip device of claim 1, wherein the top surface and the bottom surface are substantially flat.

13. The clip device of claim 10, wherein the body includes a distance from the top end to the bottom end, wherein the distance is less than about 5.5 cm.

14. The clip device of claim 10, wherein the body includes a distance from the top end to the bottom end, wherein the distance is less than about 10.5 cm.

15. The clip device of claim 1, wherein the portion of the bottom surface including an adhesive is an area defined between the top end and the bottom end and the second end and a distance less than about 0.5 cm from the second end.

16. A method of using a clip device, the method comprising
securing a body section of the clip device to a substantially cylindrical binding mechanism using at least one appendage,
wherein the body section includes a top surface, a bottom surface, a first end, and a second end, wherein at least a portion of the top surface includes an adhesive.

17. The method of claim 15, further comprising:
peeling a cover off the adhesive to expose the adhesive.

18. The method of claim 16, further comprising:
attaching a loose article to the adhesive thereby securing the loose article to the substantially cylindrical binding mechanism.

19. The method of claim 15, wherein the securing includes using force to snap the at least one appendage into an opening between two adjacent sections of the substantially cylindrical binding mechanism.

20. The method of claim 15, further comprising:
securing a body section of at least a second clip device to the substantially cylindrical binding mechanism using at least one appendage on the second clip device.

21. The method of claim 16, further comprising:
attaching a loose article to the adhesive on the first body section and the adhesive on the second body section thereby securing the loose article to the substantially cylindrical binding mechanism.
